(19) United States
(12) Patent Application Publication
(10) Pub. No.: US 2025/0367672 A1
(43) Pub. Date: Dec. 4, 2025

(54) HINGED BOX OPENING MECHANISM AND ASSOCIATED METHODS

(71) Applicant: LABRAT D'OR INC., Calgary (CA)

(72) Inventor: Jeroen DE BUCK, Calgary (CA)

(73) Assignee: LABRAT D'OR INC., Calgary (CA)

(21) Appl. No.: 18/852,336

(22) PCT Filed: Apr. 20, 2023
(86) PCT No.: PCT/CA2023/050535

§ 371 Date: Sep. 27, 2024

Related U.S. Application Data
(60) Provisional application No. 63/334,146, filed on Apr. 24, 2022.

(51) Int. Cl. B01L 9/00

(52) U.S. Cl. CPC B01L 9/543; B01L 2200/141; B01L 2300/023; B01L 2300/043; B01L 2300/123

(57) ABSTRACT

An apparatus is described to open and close a hinged box, such as those used to hold pipette tips, when a pipette is being used, for example, by sending a signal when the pipette is taken off a pipette stand, or by activating a button or switch on the pipette. The apparatus may have a resilient arm which reaches over the pipette box to facilitate opening and closing of the box. The method enables a clean and organized workspace. It may allow for more efficient pipetting and reduces awkward handling of items. Furthermore, it prevents contamination of tips by dust, aerosols and airborne contaminants, and of tip boxes by direct contact.

### RELATED APPLICATIONS

This application claims priority to U.S. Provisional Application number 63/334,146 entitled, “Automatic Pipette Tip Box Opening and Closing Mechanism and Control” which was filed on Apr. 24, 2022, the contents of which are hereby incorporated by reference.

### TECHNICAL FIELD

The invention relates to a mechanism to open and close hinged boxes, such as those used to hold pipette tips.

### BACKGROUND

Wet laboratory work requires the handling and dispensing of small volumes of liquids. This is often done using a pipette (sometimes spelled as pipet) which uses plastic disposable pipette tips. The volumes range from 0.1 microliter to 1 or a few milliliters. Pipettes (either manual or electronic) are produced for different ranges of volumes. Each of these pipettes require the appropriate size tips to aspirate and expel the liquids. Typical ranges are 0.1-2 μl, 1-10 μl, 10-100 μl, 20-200 μl, 100-1000 μl. These tips are held into boxes, typically 96 units per box, sold filled or refillable. The filled boxes are often sterilized by autoclaving.

It is often important to keep these tips clean and/or sterile. Dust, aerosols and air-borne contaminants pose a constant risk to lab experiments, especially when working with RNA or cell cultures. This can be aided by keeping the boxes closed so that airborne contaminants don't fall into or onto the tips or in the box.

It is often important to minimize the contact between the user and the tip box for the same reason.

The frequent opening and closing of these boxes, especially if the user is handling pipettes, tubes or other lab equipment or disposables, can be inconvenient.

Procedures or samples that require strict sterility or protection from cross-contaminants are often done in filtered laminar flow biosafety cabinets or PCR hoods. Even then, turbulent airflow inside the cabinet or hood might pose risk of contamination. Also, opening and closing the boxes might require the laboratory worker to reach over other items that require to be kept sterile and contaminant free. This causes risk or inconvenience.

It is also possible that the boxes are accidently left open once the pipetting is completed which would increase the change of contamination.

### SUMMARY

In accordance with the invention, there is provided an apparatus for opening a hinged box, the hinged box comprising a container and a lid connected to the container via a hinge, the apparatus comprising:
a base for gripping the container;
an actuator connected to a rear side of the base;
a resilient bendable arm extending from the actuator towards a front side of the base and having a connector for connecting to a front side of the lid,
wherein, the actuator is configured to move between an open position and a closed position, wherein:
   in the open position, the arm is positioned such that the connector is towards the rear side of the base such that a connected hinged box is open; and
   in the closed position, the arm is positioned such that the connector is towards the front side of the base to allow the connected hinged box to be closed.

The base may be configured to be releasably connectable to the container. The connectoy may be configured to be releaseably connectable to the lid. The arm may be closer to the front in the closed position relative to the open position. The arm may be long enough such that, when the actuator is in the closed position, the connector can touch the front side of the base. In the open position, the arm may hold a connected hinged box lid open.

The apparatus may comprise a receiver for receiving a control signal from a remote transmitter, wherein the actuator is controlled based on the received control signal.

The apparatus may be configured to, in response to receiving the same signal repeatedly, alternate between moving the actuator to the open position and moving the actuator to the closed position.

The apparatus may be configured to move the actuator from an open position to a closed position in response to a time period from a last received control signal exceeding a predetermined threshold.

The control signal may be one or more of: a radiofrequency signal and an infrared signal.

The arm may be resilient to bending.

The arm may comprise plastic tubing.

The connector may be configured to connect to a latch positioned on the front side of the lid.

Moving the arm between an open position and a closed position may comprise: moving the actuator end of the arm (e.g. moving it rearwards) and/or changing the orientation of the actuator end of the arm (e.g., by rotation).

According to a further aspect, there is provided an opening assembly comprising: a remote transmitter configured to emit a control signal, and the apparatus described herein, wherein the apparatus comprises a receiver for receiving the control signal, wherein the actuator is controlled based on the received control signal.

The remote transmitter unit may be part of a mechanical pipette.

The remote transmitter may be part of a unit configured to be releasably attachable to a pipette.

The unit may comprise an elastic band for connection to a pipette.

The unit may comprise a transparent elastic band, the elastic band being configured to act as a light guide to transmit an infrared signal received from an emitter, and to disperse the received infrared signal in a range of different directions.

The remote transmitter may be configured to emit a control signal in response to a pipette being removed from a pipette stand.

The remote transmitter may be configured to emit different control signals in response to respective different user inputs, each different control signal being associated with a different box.

The remote transmitter may comprise an optical component for dispersing the control signals emitted in a range of different directions.

According to a further aspect, there is provided a box assembly comprising: the apparatus as described herein, and a hinged box comprising a container and a lid connected to the container via a hinge, wherein the container is gripped by the apparatus base, and a lid end of the resilient arm is connected to the front of the lid opposite the hinge.

According to a further aspect, there is provided a method for controlling the opening and closing of a hinged box,
the hinged box comprising a container and a lid connected to the container via a hinge, the apparatus comprising:
a base for gripping the container;
an actuator connected to a rear side of the base;
an arm extending from the actuator towards a front side of the base, the arm being formed from a resilient material, and having a connector for connecting to a front side of the lid,
the method comprises moving the actuator between an open position and a closed position, wherein:
   in the open position, the arm is positioned such that the connector is towards the rear side of the base such that a connected hinged box is open; and
   in the closed position, the arm is positioned such that the connector is towards the front side of the base to allow the connected hinged box to be closed.

The arm may be formed from a single resilient material (e.g., plastic tubing).

The arm may be bendable to allow a variety of configurations when connected to two fixed points at either end (e.g., when connected to the actuator at one end and the lid in the closed configuration at the other end). E.g., the path of the arm over the box is not fixed, or uniquely defined, by the position (and possibly the orientation) of the two ends.

The arm may comprise a connector at either end. The arm may be connected to a lid connector for attachment to the lid (often a latch of the lid) of the box.

The resiliency of the arm may be such that when the two end points are fixed, there is one configuration which has the lowest energy. Bending the arm away from this lowest-energy configuration (i.e., while keeping the two ends fixed) may increase the potential energy stored within the arm such that, when the arm is released, the arm will be induced to return towards the lowest energy configuration. It will be appreciated that this resiliency will also allow a force to be transmitted from one end of the arm to the other by moving one of the ends. E.g., when the actuator moves the actuator end of the arm, a force will be transmitted through the arm and applied to the lid end of the arm to move the box between the open and closed configurations.

In other embodiments, force transfer by the actuator can work in both ways through a flexible arm without this principle. Just back and forth, push and pull.

The pipette may be a mechanical pipette.

The hinged box may be between 5 and 25 cm high (vertical in-use dimension transverse to the hinged axis). The hinged box may be between 5 and 30 cm wide (i.e., along the hinged axis). The hinged box may be between 5 and 30 cm deep (i.e., horizontal in-use dimension transverse to the hinged axis).

The user interface element may be a button or switch. The user interface element may be a physical user interface element or a virtual user interface element (e.g., a virtual button displayed on a touch screen).

A user interface element may comprise a touch sensor. The touch sensor may be affixed to any surface of the pipette (e.g., on the pipette body) to allow the user to control the transmitter. The touch sensor may be affixed using glue. This may allow the user to select where on the pipette the user interface element is located. A touch sensor may comprise a TPP223 chip, or similar. Such chip detects changes in capacitance on the surface, which occur when a person touches the surface. The chip can then trigger the output signal that serves to control the actuator of the base of the box.

Different switches may be used, including toggle switches, pushbutton switches, touch switches, selector switches, joystick switches, limit switches, proximity switches, speed switches, pressure switches, temperature switches, liquid level switches, liquid flow switches, level switches, magnetic switches, reed switches, toggle switches, slide switches, tactile switches, rocker switches, DIP switches, PMIC (Power Management Integrated Circuit) switches, rotary switches, selector switches, snap action switches. Different sensor-based switches may be used, including light switches, capacitance sensors, temperature sensors, pressure sensors, motion sensors, proximity sensors or others.

The arm may be flexible. The arm may be of a fixed length (e.g., be inextensible). The arm may be resilient to bending (e.g., applying a displacement transverse to the arm axis induces a restoring force transverse to the axis opposite to the displacement). The arm may be resilient to extension (e.g., applying a displacement along to the arm axis induces a restoring force along the axis opposite to the displacement). Being resilient means that even if the actuator moves quickly the arm will bend first giving a smoother opening motion. It may also allow the latch to be opened forward even as the rear of the arm is moving backwards. It may also allow for direction of the opening of the lid to be upwards even as the arm moves backwards. The connector between the arm and the lid (via latch) may help in directing the force provided by the actuator through the arm by including a lever that pivots on the lid of the box.

The connector between the arm and the lid, sometimes part of the arm, may clip onto the latch, often by press and release mechanism, often by clipping inside of the hole in the latch.

A hinged box may be substantially rectangular in horizontal cross section. A hinged box may comprise a hinge positioned at the rear of the box. The connection between the lid and container of the hinged box may be substantially parallel to the bottom surface of the container. A hinged box may comprise a rack (which may be exchangeable) with an array of holes for holding pipette tips. The top surface of the rack may be substantially parallel to the bottom surface of the container.

The apparatus may be configured to rotate the lid of the box by at least 80° between the closed position and the open position.

Opening of a tip box may be enabled by a base holding the box and an electromotor incorporated into the base and gears or a lever connecting the motor axis and horn to the lid of the box.

Opening of a tip box may be triggered by a switch or sensor, the former can be manually or automatically activated, the latter either detecting the presence or absence of a pipette or the movement or placement of the pipette or the actions, motion or position of the user or a part of the user.

The signal may be transmitted by wires, or wireless by radiofrequency signals, infrared signals, WIFI signals, Bluetooth or other electric or electromagnetic connection.

An electronic circuit may receive the signal and initiate opening and/or closing. The signal may be pulse width modulated (PWM) for one or more motors.

The system may be controlled by either a programmable microcontroller or by electronic components and circuits receiving signals from the user, the pipettes or pipette holder or stand, and generating the signal for the servos or other signals for other motors. Other electromotors might just be turned on or off manually.

Motors (e.g., servos) used to open the boxes may or may not be controlled by Pulse Width Modulation (PWM) signals are generated with integrated circuits, including timer integrated circuits (like NE555 chip) or by microcontrollers.

A microcontroller may detect different input signals and drive different motors. The speed of opening and closing can be controlled by how the pulse width changes over time (e.g., using a servo). Other motors may control the speed using different voltages.

An Arduino™, Raspberry Pi™ or other circuit boards may be used. These boards can be programmed with an integrated development environment software (IDE). E.g., Arduino sketches can be uploaded including the servo.h library for convenient control.

The motor may be placed on a base plate holding the tip box or directly onto the tip box. This base may be universal or customized to the different shapes of the boxes by pipette tip manufacturers or sellers. The universal base may use adjustable members, such as inserts fitting different sized boxes, springs, elastic bands and/or clamps, to clamp a box and keep it in place.

The pipette holder may be modified or customized to hold specific brands and types of pipettes.

The base can be designed to be modular so that multiple units can easily connect to the main unit which contains the controlling electronics. This can be done by interlocking base units (e.g., with complementary shapes, like puzzle pieces) or by connectors.

Power to actuator and the electronics (circuit board) of the base can be via power cord to each of the modules separately or to one module which then transfers the power from module to module by wires or by a connector (e.g., magnetic connector).

Power to the base can be from an outlet or battery pack.

The actuator may be one or more of: an electromotor (e.g., servo, stepper), a relay, and a motor.

The motor may create a motion to open the box by creating a torque on the hinges of the lid of the box or by other linear or circular motion. In one embodiment, the motor is placed at the side of the box, from the perspective of the user (e.g., who would be positioned at the front of the box away from the hinged side). In another embodiment, the motor is placed behind the box (e.g., adjacent to the hinged side) and connects via a arm to the lid of the box. The connection may be at the front of the lid of the box. This can be the lip or latch of the box closing mechanism. The arm or arm may be curved, straight, or a combination of curved and straight connectors. The arm may connect to horn on the servo shaft and or connected to the tip box. The arm may be rigid or soft or flexible. This arm can consist of rigid or flexible plastic tubing. This arm connects directly to the shaft of the motor or to the horn.

The arm (or lever) may have a connector which makes it easy to link to the lid of the box. This connector may be a hook, it may be a squeeze-and-release mechanism, it may be a twist lock (e.g., a turn lock), and/or contain a magnet or spring. The connector may also be made of Velcro, connecting to the Velcro stuck to the lid of the box. The connector may comprise a suction cup.

The rotary motion of a servo or other type of motion can also be converted to linear motion to open the box. This conversion may be done by slider-crank mechanism, by lead screw mechanism, by camshaft mechanism, by ball screws, by roller screws, scotch yoke, linear actuators, by rack-and-pinion gear mechanism, or sprocket and chain/belt mechanisms.

The arm may comprise a string, a wire or coil, which is either pulled or rolled up to create tension to open the box. A spring can be involved to either open or close the box. In some embodiments, the arm may be flexible, but not resilient (e.g., a string).

The arm may be adjusted to the different box opening systems (e.g., to adjust for hinges, lips, latches etc.).

The mechanism to open and close the lid of the tip box may contain one or more pneumatic pistons.

The base may contain covers that move over the entire lidless tip boxes. Alternatively, the base might consist of tip boxes in which refill tip ‘wafers’ or ‘racks’ can be mounted, whereby attached lids are mechanically controlled to open and close.

Typically, each individual tip box has a motor or actuator and can be individually triggered. However, one motor may be geared up to open multiple boxes.

One or more pipettes or triggers can open the same box. This is useful if more than one pipettor needs to open the same box.

One or more motors may be simultaneously controlled to open and close a tip box. One or more motors might drive opening the box, while one or more different motors might drive closing the box.

The integrated circuit with microcontroller can also be used to measure how long a box has been opened. In response to the measured duration of how long the box has been opened, the system may be configured to initiate an alarm and/or automatically close the box (e.g., if the measured duration exceeds a predetermined threshold).

The opening/closing mechanism can also be programmed to follow specific protocols and programs. The mechanism can also be incorporated in larger liquid handling robotic or automated systems.

In the embodiment where a signal is generated by an electronic device attached to the pipette, different signals may be generated by different pipettes to open the matching box. Such signals can be coded by modulation of the electromagnetic signal. PWM modulation or other modulation. In the case of the use of IR emitters and receivers, modulation can also be used, identical or similar to consumer IR (infrared) remote control communication protocols for consumer electronics (e.g., RC-5 and NEC protocols). This can be either high frequency modulation or low frequency. The former often uses microcontrollers or ICs (e.g., NE555 type), optocouplers, or led flashing circuits.

The transmitter may be attached to the pipette by glue, by putting inside a sleeve or band, by a clamp or other fastener. The transmitter can also be temporarily attached via Velcro or similar reusable mechanism.

The IR light source of the transmitter can be integrated in a semi-translucent or translucent band around the pipette which the serves as a light guide to transmit the IR signal in a wide angle, up to 360 degrees (e.g., and at least 270 degrees), so that it can reach the sensor on the base without having to point the IR light source.

The transmitter may be integrated into the pipette housing. In another embodiment, the transmitter is integrated into the electronics of an electronic pipette and connected to either separate battery or connected to the main battery of this electronic pipette.

The transmitter may have a coin battery, a rechargeable battery, a supercapacitor and/or might be powered by solar cells.

Instead, or in addition to pipette specific sensors, extra proximity sensors can be included, positioned so that either all boxes are opened upon triggering, or individual boxes can be opened or closed.

The method may be configured to open and close a pipette tip box.

The method may be configured to open and close a pipette tip box without touching it.

The method may comprise transmitting a signal to the tip box opening mechanism to open or close. The signal may be an electromagnetic signal.

The opening and closing may be controlled by a system incorporated in pipette stand or holder.

The mechanism may comprise a servo, stepper or other electromotor.

The method may be comprise detecting the presence of pipette on pipette stand or holder.

The opening and closing may be controlled by a switch (e.g. a magnetic, light, pressure, and/or capacitance switch). The switch may be mounted on a pipette.

The opening and closing may be controlled by detecting handling of a pipette.

The method may comprise identifying each box within a plurality of boxes, and selectively opening an individual box based on which pipette is being used.

Herein discussed are methods to open pipette tip boxes without direct contact with the tip box.

A motor is incorporated into a base holding the tip box. This motor drives a mechanical mechanism, contain either gears or a flexible arm or lever, possibly a flexible lever, connected to the lid of the box, or both. The opening and closing of the box may be triggered by a signal. This signal is either coming from the user directly or from an intermediate device. An electric or electromagnetic signal is sent to a controlling circuit, containing ICs, microcontrollers, inside the base.

The trigger might be connected to a pipette stand and related to the presence or absence of pipettes. The trigger might be given by the user who purposely turns or activates a switch or who automatically turns a switch when handling the pipette. The mechanism opens the correct tip box corresponding to the cognate pipette.

In the context of this disclosure, references to directions such as upwards and downwards may be taken in relation to the apparatus being in use with the base resting on a horizontal surface.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1a is a side view of a first embodiment of an apparatus for opening a hinged box, such as a pipette box, when connected to the hinged box in a closed configuration.

FIG. 1b is a side view of the embodiment of FIG. 1a in an open position.

FIG. 2a is a perspective view of a second embodiment of an apparatus for opening a hinged box, such as a pipette tip box, when connected to the hinged box in a closed configuration, and an associated pipette.

FIG. 2b is a front cross-section view of a connector for connecting the flexible arm of the embodiment of FIG. 2a to the lid of the hinged box.

FIG. 2c is a side view of the connector of FIG. 2b when the latch is engaged.

FIG. 2d is a side view of the connector of FIG. 2b when the latch is disengaged.

FIG. 3a is a cross-sectional view of a releasably attachable unit comprising a user interface for controlling the opening and closing of a hinged box.

FIG. 3b is a perspective see-through view of the body of the releasably attachable unit of FIG. 3a.

FIG. 4 is an overhead view of a series of apparatus bases connected together.

### DETAILED DESCRIPTION

### Introduction

The present disclosure relates to a reliable mechanism of closing and opening a pipette tip box whereby the base holding the tip box in place contains an actuator (e.g., a motor with gears) and a flexible arm. The apparatus may be controlled using a wired or wireless control.

A mechanism is described to open and close the boxes when the pipettes are handled, either by sending a signal when the pipette is taken off a pipette stand, or by activating a switch on the pipette.

The method enables a clean and organized workspace. It allows for more efficient pipetting and prevents awkward handling of items when opening the box. Furthermore, it prevents contamination of tips, it avoids leaving pipettes on the bench. It keeps the tip boxes organized and in specific spot. Finally, it can help with keeping pipettes in a dedicated spot.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

### First Embodiment

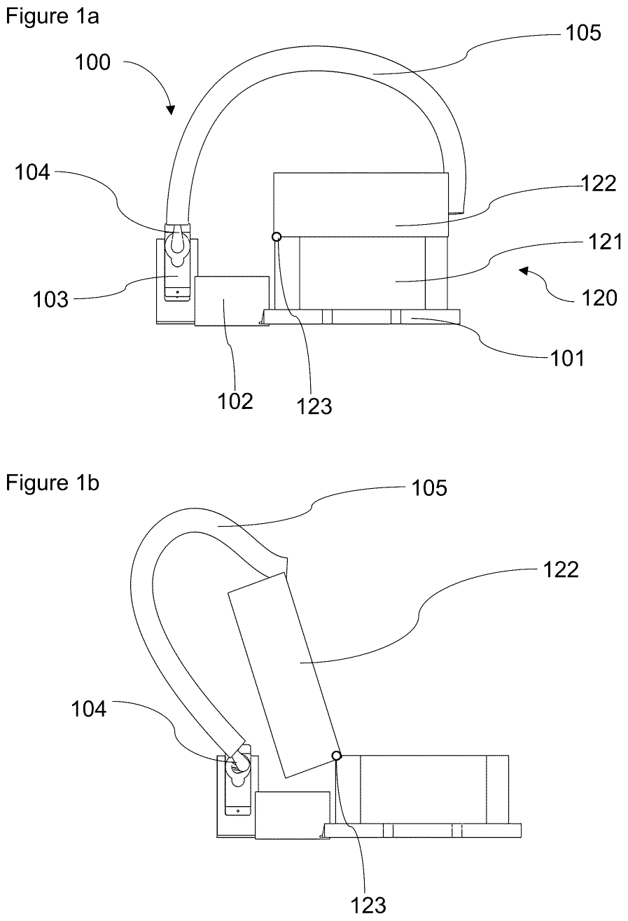

FIGS. 1a and 1b show a first embodiment of an apparatus 100 for opening a hinged box, the hinged box 120 comprising a container and a lid connected to the container via a hinge, the apparatus comprising:
a base 101 for gripping the container;
an actuator 103 connected to a rear side of the base;
an arm 105 extending from the actuator towards a front side of the base, the arm being formed from a resilient bendable material, and having a connector for connecting to a front side of the lid,
wherein, the actuator is configured to move between a closed position and an open position, wherein:
   in the closed position, the arm is positioned such that the connector is towards the rear side of the base to allow the hinged box to be closed; and
   in the open position, the arm is positioned such that the connector is towards the front side of the base such that the hinged box is open.

The box 120 in this case comprises a container 121 and a lid 122 which is connected to the base via a hinge 123. The hinge defines the rear of the box, and a hinge rotation axis about which the lid of the box rotates with respect to the container. When the box is connected to the apparatus, the box is positioned within the base such that the hinge is towards the rear of the apparatus, and the resilient bendable arm is passed over the top of the box and connected to the lid at the front (i.e., the side opposite the hinge).

In this case, the base grips the bottom of the container using resilient grips. The grips are placed within a recess in the base. The base has four sides configured to constrain lateral motion of the box within the recess. One or more of these sides may be moved in and out to grip the base of the box.

The base in this case comprises a rearward projection onto which the actuator is mounted. In this case, the actuator (e.g., the rotation member) is mounted centrally with respect to the base along the actuator axis. This means that when the resilient bendable arm is passed across the box in a direction transverse to the actuator axis, it will connect at the center of the front of the box. The rearward projection also permits the actuator to be spaced apart from the back of the box to allow the resilient arm to move between the open and closed positions without inducing too much bending of the arm at any point.

In this embodiment, the actuator 103 comprises an electromotor. In this case, the electromotor is configured to rotate a rigid rotation member 104 (e.g., comprising a horn) about an actuator axis. In this case, the actuator axis is parallel to the hinge axis, and the rotation member extends transversely from the actuator axis. To move from the closed position to the open position, the top of the rigid rotation member moves backwards.

In this embodiment the top of the rigid rotation member is configured to be substantially at the same height as, or higher than, the hinge and/or where the resilient arm connects to the lid. This means that rearward motion of the top of the rigid rotation member applies a rearward, and possibly a slightly upwards, force on the front of the lid.

The rigid rotation member may be spaced apart from the back of the hinged box. The distance between the hinge axis (or the back of the base for gripping the box) and the actuator axis may be at least 25% (or at least 50%) of the distance between the hinge axis and the front of the lid (or between the back and front of the base for gripping the box). This spacing allows the lid of the box to be opened fully without inducing too much curvature in the resilient arm. In use, the resilient arm may be 1.4-1.8 times the linear distance between the actuator axis and the front of the lid (and/or the front of the base). If the actuator axis is level with the front of the lid, a resilient arm with a length π/2 (≈1.57) times the linear distance between the actuator and lid front would form a smooth semicircle.

In response to a signal, the actuator is configured to move the horn between an open position, as shown in FIG. 1b, to a closed position, as shown in FIG. 1a. In this embodiment, in both the open and closed positions, the rotation member extends generally upwards above the horizonal (e.g., away from the bottom of the base). In the closed position, the distal end (e.g., the end of the rotation member away from the rotation axis) of the rotation member is rotated towards the front of the apparatus, and in the open position, the distal end is rotated towards the rear of the apparatus. It will be appreciated that, in the open position, even when the center of mass of the lid is behind the hinge axis, the resiliency of the arm can allow the actuator to move the lid forward using the arm. In embodiments with flexible non-resilient arms, the open configuration be such that the center of mass of the lid is still in front of the hinge axis. This means that, when the actuator moves the arm forward, the centre of mass of the lid will allow the lid to close. In some embodiments, there may be a block (e.g. positioned behind the lid) limiting the degree to which the lid can open. This may help allow the lid to be closed using the apparatus.

The resilient arm in this embodiment is connected to the rotation member at an actuator end, and the front of the lid at a lid end. In this case, the resilient arm is hollow at the actuator end and receives the rotation member. When the actuator moves from the closed position to the open position, the rotation of the distal end of the rotation member rotates the actuator end of the resilient arm backwards. This motion is transmitted to the lid end through the resiliency of the arm and also draws the front of the lid backwards. As the lid is constrained to rotate about the hinge axis, this action opens the box.

Conversely, when the actuator moves from the open position to the closed position, the rotation of the distal end of the rotation member rotates the actuator end of the resilient arm forwards. This motion is transmitted to the lid end through the resiliency of the arm (e.g., between the end of the rotation member and where it connects to the lid) and also moves the front of the lid forwards. The front of the lid is the side of the lid furthest away from the hinge side. As the lid is constrained to rotate about the hinge axis, this action closes the box.

In this case, the arm is formed from a resilient material, and the resistance to bending is substantially constant along the length of the resilient arm (e.g., the bending stiffness of the elastic member at any point along its length may be within 20% of the mean average at all points).

In this case, the apparatus comprises electronics 102, including a receiver for receiving control signals from a transmitter. The actuator 103 is controlled by the electronics based on these received control signals.

### Second Embodiment

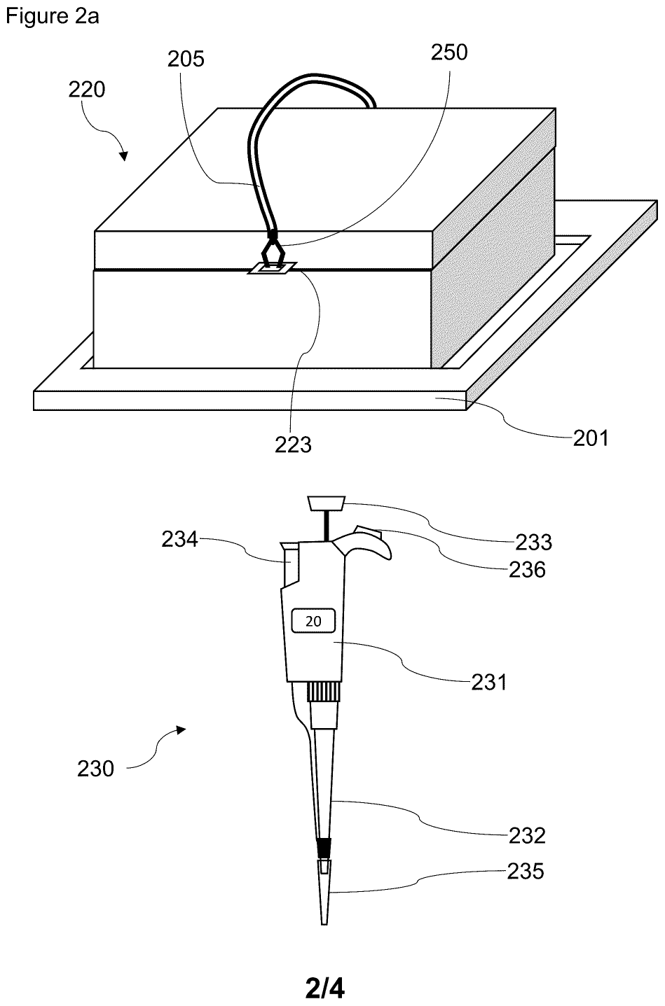

FIGS. 2a-d shows a second embodiment of an apparatus for opening a hinged box 220, the apparatus comprising:
a base 201 for gripping the container;
an actuator connected to a rear side of the base;
an arm 205 extending from the actuator towards a front side of the base, the arm being formed from a resilient material, and having a connector for connecting to a latch connector of a hinged box gripped by the base,
wherein, the actuator is configured to move from an open position and a closed position, wherein:
   in the open position, the arm is positioned such that the connector is towards the rear side of the base such that a connected hinged box is open; and
   in the closed position, the arm is positioned such that the connector is towards the front side of the base to allow the connected hinged box to be closed.

In this embodiment, as shown in FIGS. 2c-d, the resilient arm is connected to a latch 223 on the front side of the lid. In this case, the latch comprises a deformable region 264 of the front of the lid of the box, a lid clip portion 262 which extend rearwards towards the hinge for connecting to a corresponding forward extending container clip portion 263, and an external handle 261 which may be used to move the lid clip portion with respect to the base clip portion to engage and disengage the latch. The latch is configured to rotate about an axis parallel to the hinge axis. When the lid and container clip portions are engaged, the latch is engaged, as shown in FIG. 2c. To disengage the latch, the lid clip portion is rotated forward (e.g., with the lid clip portion moving away from the hinge) which disengages the latch, as shown in FIG. 2c, and allows the box to be opened.

In this embodiment, the resilient arm is connected to a connector 250 to engage with the latch.

As shown in FIG. 2b, the connector 250 in this case comprises a bulbous coupling 251 at a proximal end which is configured to be inserted securely within a resilient tubing. In other embodiments, the connector may be, for example, glued or tied to the flexible arm.

At a distal end, this connector 250 comprises two resilient arms 252a,b, each arm having a C-shaped handle engagement members 254a,b. In this case, the handle has a hole 266, into which the C-shaped handle engagement members 254a,b can be inserted. The resilient arms 252a,b are configured to move the C-shaped handle engagement members away from each other to engage with the edges of the handle hole. This secures the connector to the handle in this case. In other embodiments, for example, where the handle does not have a hole, the connector may be configured to grip the outside of the handle, e.g., by applying an inward force between two arms.

As shown in FIGS. 2c and 2d, in order to disengage the latch 223, the connector 250 in this case comprises pivot members 253a-b. The pivot members 253a-b are positioned on each arm, and extend laterally away from an axis between the coupling for connecting to the resilient arm and the engagement members for connecting to the handle. In use, the pivots 253a-b in this case engage with a front surface of the lid, such that when the resilient arm moves the coupling rearwards, the deformable portion 264 of the lid below the pivots rotates, moving the lid clip portion 262 forward to disengage the latch, thereby allowing the lid to move to the option position.

In this embodiment, the two pivots 253a,b are spaced apart, which helps stabilize the connector in an upright position in use. The two spaced apart pivots also help control the axis of rotation of the deformable portion of the lid by helping ensure that it rotates about an axis parallel to the hinge axis, which is required to disengage the lid and container clip portions. In other embodiments, there may be a single pivot, or more than two pivots. For example, an embodiment may have a single elongate pivot. The pivot may be configured to be positioned horizontally in use such that when the flexible arm is drawn rearwards by the actuator, the connector will pivot about an axis parallel to the hinge axis.

For the closing phase, moving the rear of the arm forward will allow the lid of the box to be closed, but may not engage the latch. Ramped portions of the lid and container clip portions may help engage the latch based on the weight of the lid. However, if desired, the user may engage the latch manually, which may require less dexterity when the latch is in position to be engaged.

In this case, the apparatus comprises electronics, including a receiver for receiving control signals from a transmitter. The actuator is controlled based on these received control signals.

In this case, the transmitter is mounted on a mechanical pipette 230. The pipette, in this case, has a body 231, a tip holder 232 for holding a pipette tip 235, a plunger 233 for drawing fluid into and emptying the attached tip. A separate button 234 is used to eject the tip after use.

In this embodiment, the control signals are emitted in response to a user interacting with a user interface element 236. In this case, the user interface element is a touch button which is positioned at the same end of the pipette as the plunger (or push button) so as to be easily accessible to the user. When the box button is depressed, a wireless control signal is transmitted to the transceiver of the box opening apparatus.

In response to receiving the control signal, electronics in the box opening apparatus is configured to actuate the actuator to move from the closed position to the open position thereby opening the tip box. This allows the user to get a tip for the pipette without directly interacting with the box. This is useful as the user's hands may be full with the pipette and other lab equipment (e.g., test tubes or other plasticware or glassware).

In this embodiment, the apparatus is configured to close the box in response to a period of time since the open control signal was received exceeding a predetermined threshold. The threshold time may be between 5 and 30 seconds (e.g., 10 seconds). This allows the user to keep the lid open for a time period longer than the threshold period by pressing the box button repeatedly.

In other embodiments, the apparatus may be configured to alternate between opening and closing in response to receiving a control signal. For example, the apparatus electronics may be configured to store the state of the box and to move to the other state in response to receiving the control signal. This system allows the user to open and close the box at any time. In other embodiments, there may be a dedicated open box button and a closed box button. An open box control signal would be transmitted in response to the open box button being pressed, and an identifiably distinct closed box control signal would be emitted in response to the closed box button being pressed. The receiver would be configured to distinguish between the open and close box control signals and operate the box accordingly.

### Coding and Control

In the embodiment of FIG. 2, the user interface used to control the opening and closing of the box comprises a single button. It will be appreciated that more complex control may be used.

For example, the same pipette maybe used with different tips within the same experiment. Therefore, there may be a need for the user to access different boxes to get different pipette tips. This may be done by configuring the transmitter such that it can emit different control signals in response to different user interactions, each different control signal being used to control a different box.

One way of doing this would be to have different user interface elements (e.g., different buttons), each user interface element being configured to control a different box. Another method would be to configure the transmitter to recognize different user interactions with the same user interface element. For example, one button push within a predetermined period (e.g. less than 2 seconds) would cause the transmitter to emit control signals for a first box, whereas a double push within the predetermined period would cause the transmitter to emit control signals for a second box.

In other embodiments, each transmitter may be configured to open a particular box. This may be useful, for example, when there are multiple different pipettes being used, each pipette having their own tips. In this case, when the user interacts with the user interface element, the correct box is controlled for that pipette.

The transmitter may be associated with particular control signals during a learning phase. In this case, a receiver may be switched into a learning mode (e.g., by switching a mode switch on the apparatus). When in a learning mode, the receiver may be configured to associate control signals emitted from a transmitter with moving the actuator between an open and closed position. This may allow the same pipette to be coded to multiple apparatus by all the multiple apparatus being in a learning mode while receiving control signals from the same pipette. It may allow the same pipette to be coded to different boxes by successively putting each of the different boxes into a learning mode and then causing the transmitter to emit particular signals for each different box (e.g., using different user interface elements or different user interactions).

### Retrofittable User Interface Unit

In the embodiment of FIG. 2, the button is an integral part of the pipette. In other embodiments, the user interface element used to transmit control signals to the apparatus receiver may be part of a unit which can be releasably attached to a pipette (e.g., at particular location or at location preferred by the user).

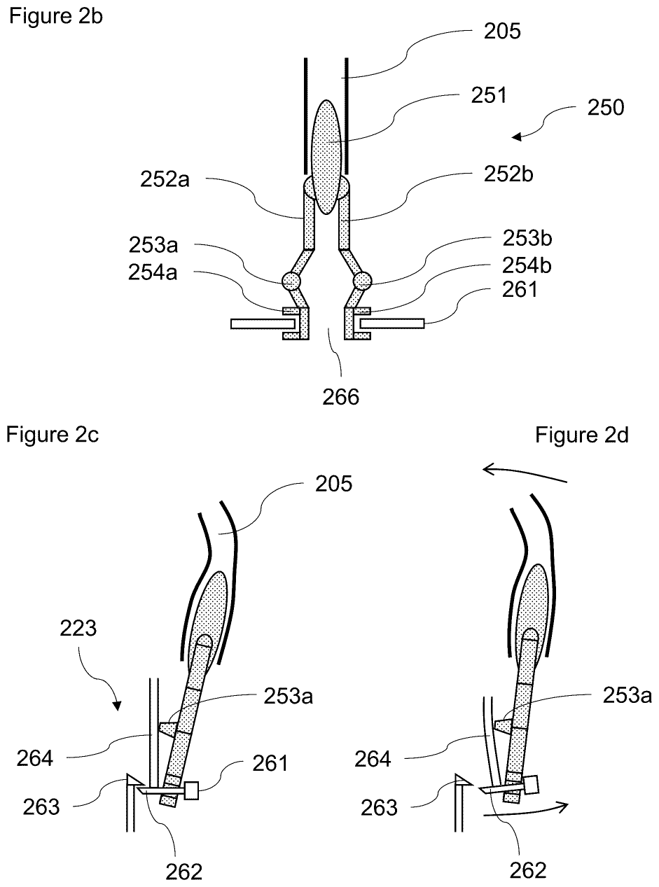

FIG. 3a shows a cross section of such a releasably attachable unit 340. The unit in this case comprises a power source 344 (e.g., a battery, cell, super capacitor or solar panel) configured to power electronics 345 and a transmitter 342. The electronics are controlled by a user interface element 343 (e.g., a button or switch). The unit comprises two resilient and concave opposing arm connectors 341a,b which are configured to grip the body of the pipette. This positions the user interface element within the range of the fingers and/or thumb of the user such that they can active the user interface element and control the opening and/or closing of the box while holding the pipette.

FIG. 3b is a perspective view of the body of the releasably attachable unit 340 with the two concave opposing arm connectors 341a,b, and a recess for housing the power source, electronics, user interface element and the transmitter.

In other embodiments, the connector for connecting the transmitter unit to the pipette may comprise an elastic band.

### Other Options

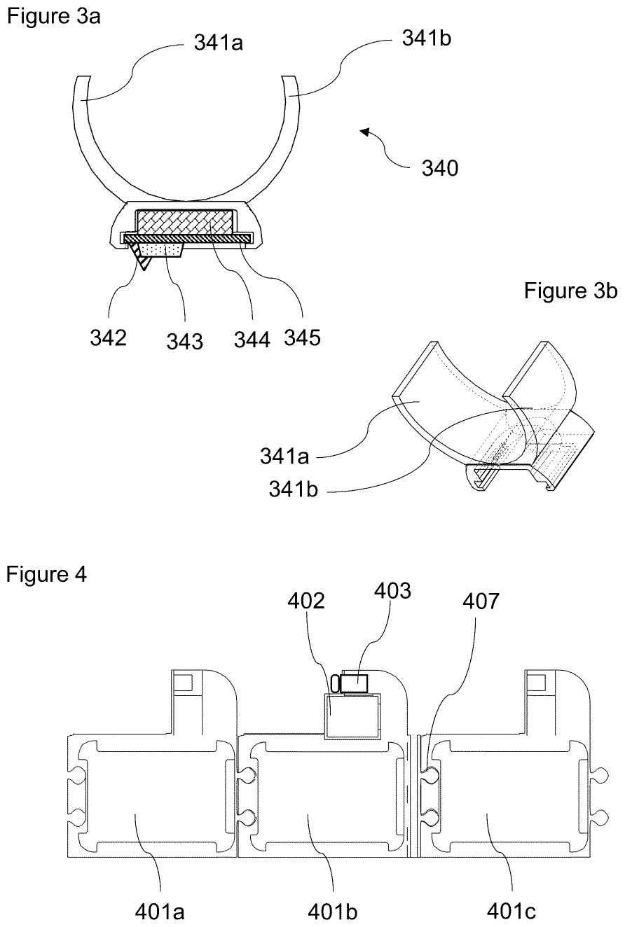

As shown in FIG. 4, several bases 401a-c may be linked together using complementary connectors 407. These bases are similar to those used in the embodiment of FIG. 1a. Each base comprises a recess for receiving a hinged box. Each recess has four sides arranged at 90° from each other. One or more of the sides may be moveable transversely to their length (i.e., in and out) to allow a box to be gripped and released. The recess has projections at the corners to allow the user to better grip the box for lifting the box from the base after use.

In this case, the complementary connectors comprise male and complementary female shapes. The male and female connectors are jigsaw connectors, and the male jigsaw connector comprises a head portion connected to the base body by a narrower waist portion. The male and female connectors 407 are connected by aligning the male and female connectors and moving them together in a direction transverse to the plane of the base. The shape of the complementary connectors mean that, when connected, they can not move with respect to each other in any direction within the plane of the connector. It will be appreciated that other connectors may be used, such as magnetic connectors, plug and socket connectors etc.

Connecting the bases in this way may allow the same actuator 403 controlled by the same electronics 402 to open and close multiple boxes simultaneously. In this case, the complementary connectors are configured to connect the bases in such a way that the back of the recesses configured to receive the boxes are aligned. This means that, when the boxes are inserted into the recesses, the hinge axes of the boxes are also aligned. The lids of the boxes can then be rigidly connected together such that, when one of the box lids is opened or closed, the lids of the attached boxes can also be opened and closed about the common hinge axis.

In the embodiment of FIG. 2, the user interface element is mounted onto the pipette. In other embodiments, the user interface element may be mounted elsewhere (e.g., on the work surface or integrated in foot paddle). For example, a user interface element may be mounted on a pipette stand such that an open box signal is transmitted in response to a pipette being removed from the stand. In this case, the user interface element may be a button which is released when the pipette is removed, or a light sensitive sensor which is activated when it detects light when the pipette is removed from the stand. In this embodiment, the apparatus may be configured to close the box in response to a threshold time period elapsing after the control signal is received.

Although the present invention has been described and illustrated with respect to preferred embodiments and preferred uses thereof, it is not to be so limited since modifications and changes can be made therein which are within the full, intended scope of the invention as understood by those skilled in the art.

1. An apparatus for opening a hinged box, the hinged box comprising a container and a lid connected to the container via a hinge, the apparatus comprising:
a base for gripping the container;
an actuator connected to a rear side of the base;
a flexible arm extending from the actuator towards a front side of the base and attached to a connector for connecting to a front side of the lid,
wherein, the actuator is configured to move the arm between an open position and a closed position, wherein:
in the open position, the arm is positioned such that the connector is towards the rear side of the base such that a connected hinged box is open; and
in the closed position, the arm is positioned such that the connector is towards the front side of the base to allow the connected hinged box to be closed.

2. The apparatus according to claim 1, wherein the apparatus comprises a receiver for receiving a control signal from a remote transmitter, wherein the actuator is controlled based on the received control signal.

3. The apparatus according to claim 1, wherein the apparatus is configured to, in response to receiving the same signal repeatedly, alternate between moving the actuator to the open position and moving the actuator to the closed position.

4. The apparatus according to claim 1, wherein the apparatus is configured to move the actuator from an open position to a closed position in response to a time period from a last received control signal exceeding a predetermined threshold.

5. The apparatus according to claim 1, wherein the control signal is one or more of: a radiofrequency signal and an infrared signal.

6. The apparatus according to claim 1, wherein the arm is resilient to bending.

7. The apparatus according to claim 1, wherein connector is a rigid elongate connector having a proximal end attached to the arm, a distal end connectable to the lid, and a pivot positioned between the proximal and distal ends, the connector being configured such that when a proximal end of the connector is drawn rearwards by the arm, the connector rotates about the pivot to move the distal end of the connector forwards to allow for disengaging the lid from the container.

8. The apparatus according to claim 1, wherein the connector is configured to connect to a latch positioned on the front side of the lid.

9. The apparatus according to claim 1, wherein the base comprises complementary connectors configured to allow the base to be connected to other bases of the same shape.

10. An opening assembly comprising: a remote transmitter configured to emit a control signal, and the apparatus according to claim 1, wherein the apparatus comprises a receiver for receiving the control signal, wherein the actuator is controlled based on the received control signal.

11. The opening assembly according to claim 10, wherein the remote transmitter unit is part of a mechanical pipette.

12. The opening assembly according to claim 10, wherein remote transmitter may be part of a unit configured to be releasably attachable to a pipette.

13. The opening assembly according to claim 12, wherein the unit comprises an elastic band for connection to a pipette.

14. The opening assembly according to claim 13, wherein the elastic band is transparent, the elastic band being configured to act as a light guide to transmit an infrared signal received from an emitter, and to disperse the received infrared signal in a range of different directions.

15. The opening assembly according to claim 10, wherein remote transmitter is configured to emit a control signal in response to a pipette being removed from a pipette stand.

16. The opening assembly according to claim 10, the remote transmitter is configured to emit different control signals in response to respective different user inputs, each different control signal being associated with a different box.

17. The opening assembly according to claim 10, the remote transmitter comprises an optical component for dispersing the control signals emitted in a range of different directions.

18. The opening assembly according to claim 9, wherein the remote transmitter is controlled by a touch sensor attachable to the pipette using an adhesive.

19. A box assembly comprising: the apparatus according to any claim 1, and a hinged box comprising a container and a lid connected to the container via a hinge, wherein the container is gripped by the apparatus base, and a lid end of the resilient arm is connected to the front of the lid opposite the hinge.

20. A method for controlling the opening and closing of a hinged box,
the hinged box comprising a container and a lid connected to the container via a hinge, the apparatus comprising:
a base for gripping the container;
an actuator connected to a rear side of the base;
an flexible arm extending from the actuator towards a front side of the base, and having a connector for connecting to a front side of the lid,
the method comprises moving the actuator between an open position and a closed position, wherein:
in the open position, the arm is positioned such that the connector is towards the rear side of the base such that a connected hinged box is open; and
in the closed position, the arm is positioned such that the connector is towards the front side of the base to allow the connected hinged box to be closed.
